(19) United States
(12) Patent Application Publication
(10) Pub. No.: US 2001/0034667 A1
(43) Pub. Date: Oct. 25, 2001

(54) System and method of bringing merchants on-line

(76) Inventor: Erik Petersen, Providence, RI (US)

Correspondence Address: Richard D. Jordan, Morrison & Foerster LLP, 2000 Pennsylvania Avenue, N.W., Washington, DC, 20006-1888, US

(21) Appl. No.: 09/765,335

(22) Filed: Jan. 22, 2001

Related U.S. Application Data
(60) Provisional application No. 60/177,268, filed on Jan. 21, 2000.

(51) Int. Cl. G06F 17/60

(52) U.S. Cl. 705/27; 705/26

(57) ABSTRACT

A system and method for gathering information off-line to bring merchants online. The system employs a sales force to gather and collect information from the merchants. The information is then used to create a “storefront”, an on-line store, such as a web page. Merchandise sold by the merchants is then made available to users of the newly created web page.

### CLAIM OF PRIORITY

This application claims priority to provisional application Ser. No. 60/177,268 filed on Jan. 21, 2000, which is hereby incorporated by reference in its entirety.

### TECHNICAL FIELD OF THE INVENTION

The present invention relates to a system and method of conducting business on-line, and in particular, to a system and method of bringing merchants on-line that do not otherwise have on-line capability.

### BACKGROUND OF THE INVENTION

On-line retailing has seen a significant “boom” in recent years following the advent of the Internet and the rise of e-commerce in general. Many large, corporate companies have taken advantage of the high-tech revolution that pervades every aspect of daily life. Consumers can now shop on-line for books, food, movie tickets, or just about any personal or business need. However, in order to have and maintain a presence on-line, companies must have sufficient resources (e.g. computers, a network, support personnel) and financing. Often times, smaller companies and individual businesses do not have the appropriate resources and financing to enter the on-line community. In fact, many owners of small business do not know how to operate a computer, much less navigate the world wide web. Hence, there exists a need for in economical and efficient system of adding off-line businesses to the “on-line” world.

### SUMMARY OF THE INVENTION

In one embodiment of the invention, there is a method of creating an on-line interface. The method includes, for example, off-line gathering of information from off-line merchants, and creating an on-line store for the off-line merchant based on the gathered information, such that on-line customers and potential customers can access the merchant's on-line store and initiate transactions which are then communicated to the merchant.

In one aspect of the invention, the method further includes, for example, storing information gathered from off-line merchants in a storage device, uploading the gathered information to a server located on a network and accessible to customers and potential customers on-line, and monitoring customer activity at the on-line store on behalf of the off-line merchant.

In another embodiment of the invention, there is a computer readable medium storing a program. The program may be used, for example, for off-line gathering of information from off-line merchants, and creating an on-line store based on the gathered information, such that customers and potential customers can access the on-line store and initiate purchases and inquiries which are then communicated to the off-line merchant.

In one aspect of the invention, the program further includes, for example, storing information gathered from the off-line merchant in a storage device, uploading the gathered information to a server located on a network and accessible to customers and potential customers on-line, and monitoring the customer activity at the on-line store on behalf of the off-line merchant.

In still another embodiment of the invention, there is a method of gathering data from off-line merchants and transmitting the data over a trans mission medium to on-line customers and potential customers. The method includes, for example, gathering data from an off-line merchant and placing it onto a storage device, downloading the merchant's data from the storage device to a server, and providing access to the merchant's data on the server to an on-line customer or potential customer at a third device, so that the on-line customer can view the data gathered from the merchant off-line.

In one aspect of the invention, the method further includes, for example, sending the data from the server to the third device, and receiving a response from the third device based on the sent data.

In yet another embodiment of the invention, there is a system for bringing off-line merchants on-line. The system includes, for example, a computer that gathers information about an off-line merchant, a server storing the merchant information gathered by the computer, and an on-line store service accessing the information on the server in order to create an on-line site that may be accessed on-line by customers, potential customers and/or other persons wishing to view information about and/or initiate transactions with the off-line merchant.

In still another embodiment of the invention, there is a method of monitoring an on-line site for an off-line merchant. The method includes, for example, monitoring the on-line site to determine whether the site has been accessed and whether a request for information has been made by an on-line visitor to the site, and forwarding a copy of the request to the off-line merchant via a transmission medium that does not require on-line access.

In one aspect of the invention, the method further includes, for example, receiving a response from the off-line merchant about the request, and updating the on-line site to reflect the merchant's response to the on-line visitor's request for information.

### BRIEF DESCRIPTION OF THE DRAWINGS

FIG. 1 is an exemplary graphical user interface in one embodiment of the invention.

FIG. 2 illustrates an exemplary system of the present invention.

FIG. 3 illustrates an exemplary system of the present invention.

FIG. 4 illustrates an exemplary system of the present invention.

FIG. 5 illustrates an exemplary system of the present invention.

### DESCRIPTION OF THE INVENTION

An embodiment of the present invention allows merchants and their customers and potential customers to conduct business on-line with the aid of an on-line service. In this regard, the merchants never actually have to go on-line. This enables merchants to broaden the pool of their customers, even when the merchant may not have the facilities (e.g. funds or know-how) to go on-line by themselves. In order to accomplish this task, information is gathered from merchants wishing to have an on-line presence (e.g. a web store), and this information is used by an on-line store service to develop an on-line store for the merchant. This on-line store, permits off-line merchants to sell, distribute and purchase on-line.

The information necessary for setting up an on-line store for an off-line merchant may be gathered from the merchant in a variety of ways. While use of a sales force is the preferred method of bringing merchants on-line, other methods may be used as well. For example, computer kiosks could be set-up for merchants who otherwise do not have access to computers. Merchants could then create their own on-line site at the kiosk by following the process noted below. Similarly, merchants could provide information to the service via mail, facsimile or the like, which information could then be used to create an on-line presence.

For example, merchants can be mailed materials for building on-line commerce capability. Merchants can identify items for sale by filling out descriptions of the items for sale (price, description, condition, etc), and might include photographs. The merchant can describe a desired format for its on-line store in writing or even draw it on a piece of paper, referring to color and font charts included with the mailed materials. The merchant then returns the package to the on-line store service by mail or fax for digitization and posting on-line.

Alternatively, a disk, or other medium, containing a program can be sent to the non-internet capable merchant. When run on a computer, the program collects the information necessary for an on-line store (via interrogatories regarding price, quantity available, condition, etc) and then stores in on the storage medium, for returning to the on-line store service for posting on-line.

Non-internet capable merchants can also supply items for sale by taking photographs of the items for sale using a digital camera provided by the on-line store service. The merchant then returns the digital camera to the on-line store service, including descriptions of the items photographed. The on-line store service then matches the descriptions to the photos, and embeds both into HTML documents to build an on-line store for the off-line merchant.

Off-line merchants can also enter information via voice. Specifically, a merchant can call a phone number that, when answered, would allow the merchant to enter information regarding the item they wish to sell, or to describe a photo of an item previously submitted. Voice recognition software at the receiving end of the phone connection may digitize the information for inclusion in an on-line store for the off-line merchant.

Also, the on-line store service could be accessed through store locations such as Kinkos™. Such stores could have an arrangement with the on-line store service to allow consumers to use their on-line store service software that is loaded into the store's computers.

Merchants and the like could also access the on-line store service through, for example, the Internet. That is, merchants could set-up an on-line site by accessing the on-line store service through the Internet. For example, merchants could use a friend's computer to set-up their on-line store.

In a preferred embodiment, a sales force, much like a door-to-door sales person, would travel from merchant to merchant collecting the necessary data to place the merchants on-line. For example, the sales force would use pre-installed software on their computers to gather merchant information such as name, address, images of items for display on the site, etc. According to a further preferred embodiment, the sales person will carry a PDA configured to gather information from the off-line merchant necessary to sell goods on-line, and/or create an on-line store. The information is then uploaded to an internet connected computer for posting on-line. The PDA, or other handheld device, might include a hand bar scanner for identifying and entering item information with a minimum of effort, insofar as that item has already been described before and can be identified via bar code (for example, if one were to scan a pair of Levi and Straus pants, the bar code sequence would identify it as such, and could therefore relate the product ID with a description in a database. The database may or may not reside with the on-line store service. It may be that the scanner information is matched with a database hosted by the vendor (for example, Levi and Strauss)

This information would then be downloaded to a server, where it would be accessible on-line to customers and potential customers.

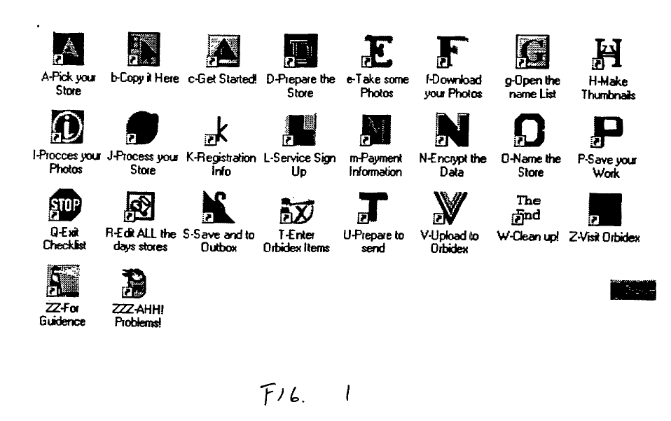

FIG. 1 illustrates an exemplary embodiment of the graphical user interface implemented in the present invention. The graphical user interface can be implemented, for example, on a personal computer accessed by a sales person/consultant. The first icon to appear on the display is the “Storebuilder” icon. This icon is selected when a merchant wants to begin the process of creating an on-line store. The first step in the process is to select a the style or motif for the on-line store by clicking on the “Pick Your Store” icon (element A).

During the “Pick Your store” function, the salesperson can display to the merchant a color template for various graphical designs for the merchant's proposed on-line store. Templates may optionally be carried on a read-only CD Rom to guarantee the original templates against corruption by editing. The aesthetics of the on-line store are the focus of this stage, although a description of the various functions of various templates may also be represented alongside the alternative graphical representations. The functions, however, will be represented by text. For example, an on-line storefront template entitled “Green Meadow” might incorporate special graphics, sound files, or video representations of a “Green Meadow” motif. The templates will be represented primarily by a visual reproduction of the designs on a web page. Web pages can be preformatted and pre-linked, or created on the fly to meet the needs of the merchant. The pages can be constructed in such a way as to automate the insertion of store specific photos of merchandise, logos, store inventory, storefronts, and other commonly desirable images useful to constructing a representative web presence for an off-line merchant. Once the merchant has selected a template, the template is then dragged to the “Copy it Here” (element B) icon so that the template folder and all of its contents are copied from the CD Rom to the correct location in the C drive. Once the template has been properly copied, the “Get Started” (element C) icon is clicked, and the system confirms that the read-only attribute has been removed from the template file. Optionally during this step, the template may be checked for syntax and the presence of necessary elements for further processing. The “Prepare the Store” (element D) icon is then selected, and the template is converted into a desire d format for further processing. For example, if the template was stored and copied in HTML format, it may be converted to XML or other XML standard format, or WAP format, accessible by other programs.

Element E, “Take Some Photos”, allows the on-line store service to incorporate photo images of items that merchants would like to display on the on-line store. In the preferred embodiment, the photos will be taken using a digital camera so that they can easily be downloaded onto the computer, as readily understood by the skilled artisan—“Download Your Photos” (element F). The photos can be displayed on the on-line site according to the “Name List” (element G). The name list is a reference available for use in naming the photo files. The name list coordinates the naming of the files with the process of inserting the photo files into their intended web page location. For example, if the merchant wants a certain image to show up as the first item of their web page, a sales person might set the designated image to appear on the first page of the web site. For example, the name “biz1” may represent the image file. The templates, however, accommodate files with an html extension, such as “B2B.htm”, and will necessarily have an html reference to the image called “biz1”, and will therefore automatically insert such a photo file into the page. Other pages use other naming conventions. In each case, if a sales consultant uses the naming list, the photos will arrive in their appointed locations in the template. “Make Thumbnails” (element H) allows the photos to be thumbnailed as readily understood in the art. The “Process Your Photos” function (element I) begins by accessing the directory that holds the thumbnailed photo files of the merchandise. The thumbnailed photos have the same name as the originals, prior to processing. This will cause an overwriting conflict when the full size originals are exported from the thumbnail directory, making directories to the template directories. Hence, the thumbnails are first renamed to avoid overwriting. For example, a suffix can be added to the name of each thumbnail file. Backups of the original full size photos are also made during the process function, in case of an error somewhere later in the “storebuilding” process. After the files are renamed, the various photo files are distributed into the template as a name dependent function. For example, if the name is “biz**.*”, where is an independent variable, then such a photo will be routed into the template directory labeled “B2B”. At the end of the process function, and after the photo files have been distributed, the directories used for processing photos are emptied to ready them for the next sales call. The “Process Your Store” (element J) function moves the template to a directory setup for access by a web page editor. The “Process Your Store” function also renames the template so that the sales person/consultant will properly rename the folder.

Elements K, L and M or “Registration Info”, “Service Sign Up” and “Payment Information”, respectively, allow the on-line store service to gather information about a particular merchant necessary for a person to be registered with the service. For example, address, phone number, type of business, etc. information is collected.

Encryption of the data that is gathered by the on-line store service occurs in element N—“Encrypt the Data”, and element O allows the merchant to “Name the Store”. The data is then stored by clicking “Save Your Work” (element P), and the “Exit Checklist” can be opened to verify that all elements in the process have been completed (element Q).

The process of bringing a merchant on-line may be completed at this element, or may be continued without the aid of the merchant. In either event, gathered information should be edited and revised by the service, as well as put “on-line” as described below.

Once the on-line store service has completed gathering information about a merchant for the database, the information is used to create the on-line store (e.g. web store). In order to accomplish this, software such as Front Page™ may be used. This software, used in conjunction with the information gathered, can be used to create and edit a web page. For example, text and images gathered from the merchant can be edited and displayed on a page to create an on-line presence (e.g. web page).

Files that have been created and/or edited are then saved and stored in the “outbox” (element S), and the files are prepared and uploaded to the server (element U). Preparation of the files include, for example, “zipping” files, converting files into executable files and protecting files with a password. Element T, “Enter Orbidex Items”, allows users to execute a program for entering large batches of items from personal computers. Files can then be uploaded to the server using the program executed in element U, “Prepare to Send”. This program also verifies that the files are not open, overwritten or different from the original files. Finally, the files are “cleaned” by executing the “Clean Up” folder (element W). The “Clean Up” function saves files that were prepared for shipping, saves the web pages after they have been edited, and saves all the files that allow the merchant's items to be loaded into the database directly. The “Clean Up” then deletes the contents in the directories that serve to hold files in preparation to their being shipped via FTP so that future file movements do not result in similarly named files being overwritten. The final three functions (elements Z-ZZZ) open a window that access a directory holding several icons representing batch files. As a group, these batch files, when executed, will serve to rebuild broken parts of the storebuilder, check for errors in the storebuilder directories, or, if necessary, completely reinstall all portions of the directory structures and their contents such that the storebuilding capability is restored to the laptop computer. This can be accomplished by accessing read only files on the source CD-ROM (or source disk) and comparing them to files and directories on the hard drive or replacing them. Other batch files, when executed, search for saved copies of the various files necessary to the “storebuilder” process—which are saved at various stages of processing—and transfer the saved copies to an area accessed by an FTP program so that the saved copies can be uploaded to the companies servers for downloading and diagnoses by skilled technicians.

Once the files have been uploaded to the server, the files can be downloaded and processed. Specifically, the files are downloaded from the server to, for example, a computer residing in a service location. The files are opened and checked to determine if any errors exist, for example to determine if the file has become corrupted during the upload process or if the photos have been misnamed causing them not to match the photo descriptions. Then, the merchant is registered with the service and a “web store” is created based on the database of information downloaded. The on-line store may include, for example, categories of information, price, items for sale, items in search of, photos, and other information. Each “web store” will have, for example, a newly created domain or sub-domain name that is associated with it. Web pages and their corresponding domain names are created as readily understood by one having ordinary skill in the art, using the information gathered off-line by the on-line store service.

It should be noted that not all of the elements are required in order for the on-line service to operate. That is, multiple variations of the process can be implemented in order to use the service.

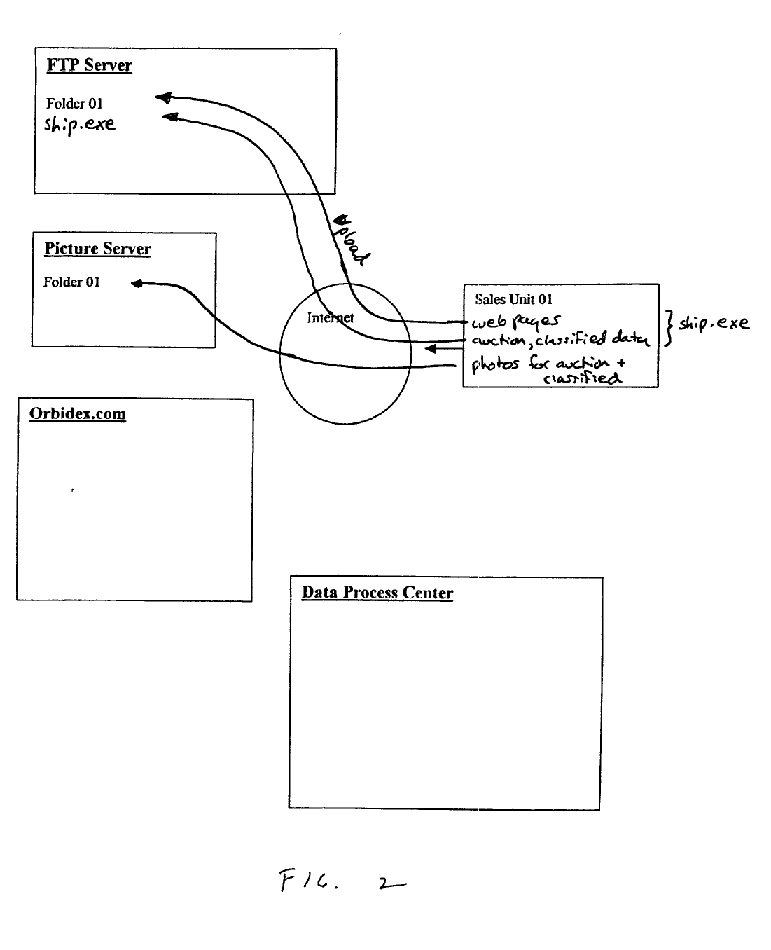

FIGS. 2-5 illustrate an exemplary system in the present invention. The system includes, for example, a network such as the Internet, a sales unit, an FTP server, a picture server, a local server, and a data processing center. The network, described as the Internet in the preferred embodiment, can be any network as readily understood in the art, including LANs, WANS, and the like. Alternatively, the network can be replaced by any means of communication data such as a dial-up network or a point-to-point connection. The sales unit may be any method or device for gathering information concerning off-line merchants that wish to have an on-line presence. It should be readily understood that the term “merchant” herein is used merely for exemplary purposes. Any individual or business can make use of the present invention to create an on-line presence when it is otherwise impossible or infeasible. The FTP server temporarily stores the information gathered via the sales unit. The picture server is used to store images used to create individual web pages and the on-line “store”. The local server stores web pages for online sites, as well as information enabling auctions and sales. The data processing center handles all data processing, including, for example, registration and credit card processing.

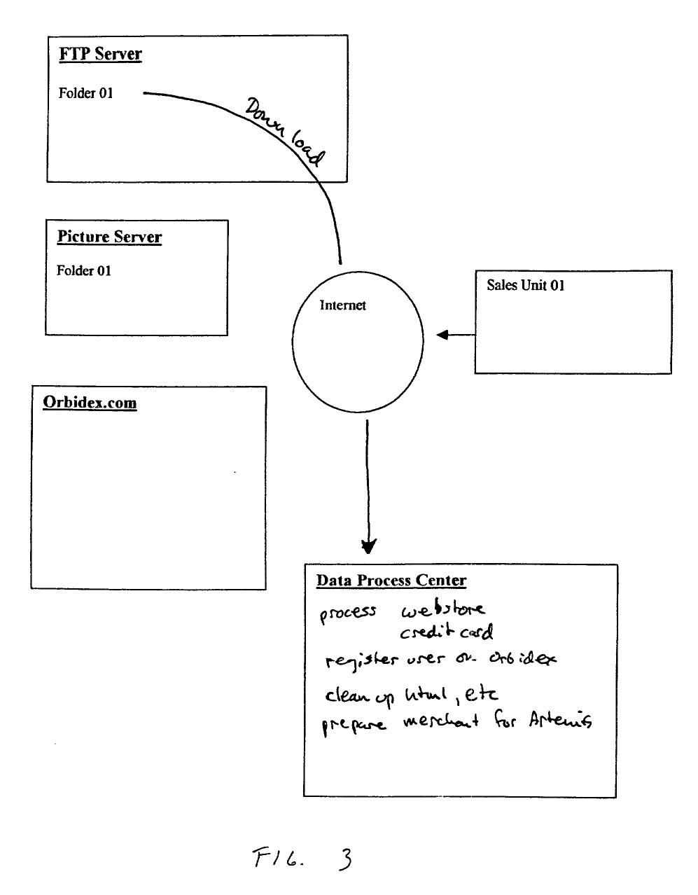

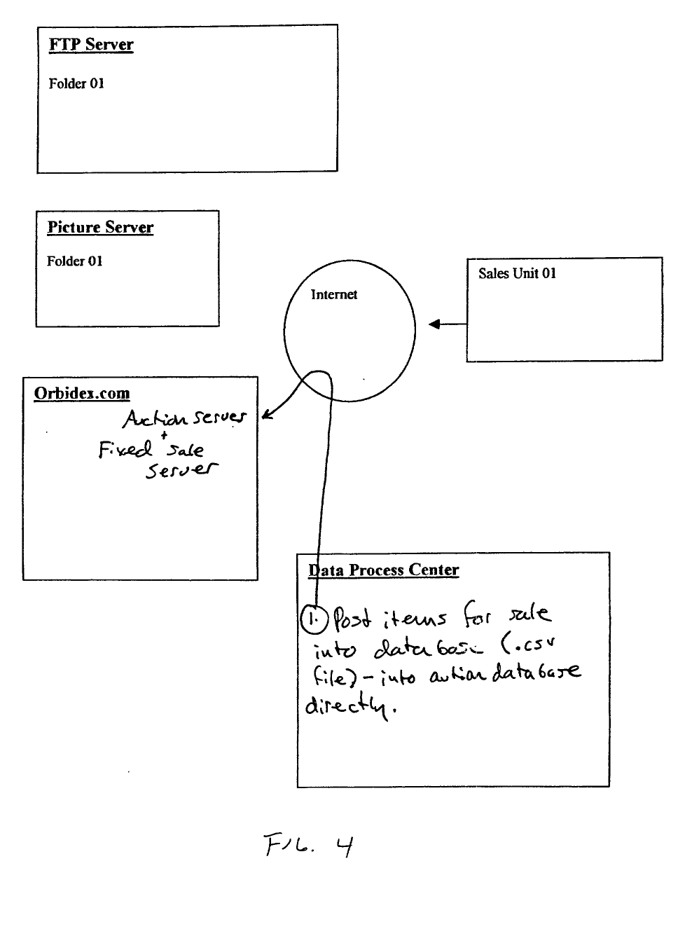

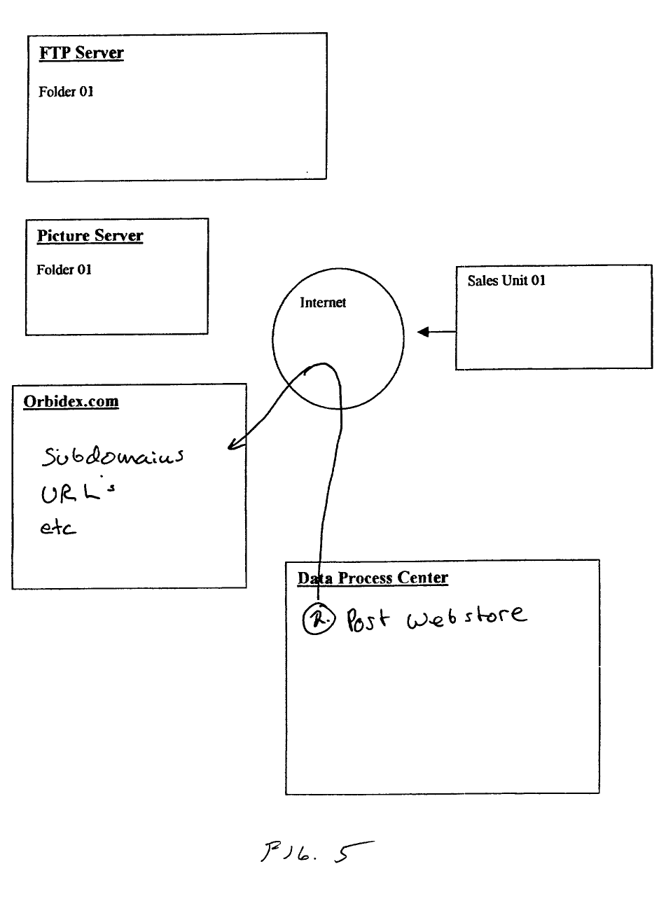

More specifically, FIG. 2 illustrates data (i.e. information) being sent from the sales unit to the FTP server and the picture server. The sales unit gathers information on, for example, a computer and uploads the it to the FTP and picture servers. Images are sent to the picture server and other data is sent to the FTP server. Other data may include credit card information for billing, bank account information for billing, details about the merchant's store (size, years in operation), shipping information, etc. Any and all information necessary to conduct e-commerce will be sent, and also any marketing information that is desirable for marketing the merchant's new on-line site. FIG. 3 illustrates data being downloaded from the FTP server to the data processing center via the network. Data includes, for example, credit card information, registration information, and data files that have been cleaned and prepared for the merchants. FIG. 4 illustrates data being uploaded from the data processing center to the local server. The data includes, for example, sales data—i.e. items to be posted for sale. This information, once received at the local server, can be placed into the auction server, or stored a fixed sale item. FIG. 5 illustrates the data processing center uploading data required to initiate, for example, a domain name and URL. This enables -the “web store” to be posted on-line.

Although the present invention has been described in detail, it is clearly understood that the same is by way of illustration and example only and is not to be taken by way of limitation.

What is claimed is:

1. A method of creating an on-line interface, comprising:
gathering information from customers off-line; and
creating an on-line store based on the gathered information, such that on-line users can access the gathered information and inquire about the information to the off-line customers.

2. The method of claim 1, further comprising:
storing information gathered from the off-line customers in a storage device;
uploading the gathered information to a server located on a network and accessible on-line; and
monitoring the on-line store on behalf of the off-line customers.

3. The method of claim 2, wherein the gathering is performed by a sales person/consultant.

4. A computer readable medium storing a program, the program comprising:
gathering information from customers off-line; and
creating an on-line store based on the gathered information, such that online users can access the gathered information and inquire about the information to the off-line customers.

5. The program of claim 4, further comprising:
storing information gathered from the off-line customers in a storage device;
uploading the gathered information to a server located on a network and accessible on-line; and
monitoring the on-line store on behalf of the off-line customers.

6. A method of gathering data from off-line users and transmitting the data over a transmission medium to on-line users, comprising:
downloading the data from a storage device to a server; and
providing access to the data from the server to a third device, such that the on-line users can view the data gathered off-line.

7. The method of claim 6, further comprising:
sending the data from the server to the third device; and
receiving a response from the third device based on the sent data.

8. A system for bringing users without on-line capability on-line, comprising:
a computer gathering information about the user;
a server storing the information gathered by the computer; and
a client accessing the information on the server in order to create an on-line site, such that the site can be accessed by on-line users.

9. A method of monitoring an on-line site for off-line user, comprising:
monitoring the on-line site to determine whether the site has been accessed and whether a request for information has been made by an on-line user of the site; and
forwarding a copy of the request to the off-line user corresponding to the on-line site via a transmission medium that does not require on-line access.

10. The method of claim 9, further comprising:
receiving a response from the off-line user about the request; and
updating the on-line site to reflect the response received by the off-line user.
